(19) United States
(12) Patent Application Publication
(10) Pub. No.: US 2011/0090152 A1
(43) Pub. Date: Apr. 21, 2011

(54) PORTABLE ELECTRONIC DEVICE WITH SWITCHABLE INPUT/OUTPUT PORTIONS

(76) Inventors: Chia-cheng Shih, Taipei (TW); Hung-Hsiang Chen, Taipei (TW); Wean-Fong Loi, Taipei (TW); Alec Wong, Taipei (TW); Xiaonan Huang, Taipei (TW)

(21) Appl. No.: 12/905,831

(22) Filed: Oct. 15, 2010

(30) Foreign Application Priority Data
Oct. 20, 2009 (CN) 200910180895.0

(51) Int. Cl. G06F 3/02

(52) U.S. Cl. 345/169

(57) ABSTRACT

A portable electronic device with switchable input/output portions is provided. A control portion is disposed at a main body module of the portable electronic device, and it includes multiple input/output portions. Only one of the input/output portions is exposed out of the main body module to allow the user to operate. In addition, the user may switch the input/output portions corresponding to different modes by rotating, sliding and other operations. This is not only space-saving, but also facilitates the operation of the user.

### BACKGROUND OF THE INVENTION

1. Field of the Invention

The invention relates to a portable electronic device and, more particularly, to a portable electronic device with switchable input/output portions corresponding to different operating modes.

2. Description of the Related Art

Desktop computer usually uses a keyboard as the input device. The keyboard includes multiple keys. In recent years, manufacturers design multiple human-based interface keys on the keyboard, such as multi-media player keyset, web browser operating keyset or user-defined hotkeys. Therefore, the user may feel convenient and intuitive in operating the desktop computer without operating too many keysets or clicking applications.

However, to a portable electronic device such as a notebook computer, since the notebook computer needs to be portable, it becomes smaller and thinner, except standard keys and a pointer input device, there is no additional space to dispose the shortcut function keys, which is inconvenient in operation. As a result, in some prior arts, functional keys may be set to achieve corresponding functions. That is, with software, a special key or keys combination are set to perform corresponding functions.

However, the functions are set by the software, it includes no corresponding symbols on the keys. If the user forgets the set function corresponding to the key, to know the corresponding function, he has to start the application or press the key to confirm. This is rather inconvenient, and the user cannot know the corresponding function intuitively.

### BRIEF SUMMARY OF THE INVENTION

The portable electronic device with switchable input/output portions disclosed in the invention includes a main body module and a control portion. The control portion is disposed in an opening of the main body module and includes multiple input/output portions. The input/output portions can be switched selectively to make one of the input/output portions exposed out of the main body module via the opening.

Therefore, one of the input/output portions of the control portion is exposed to allow the user to operate. The input/output portions corresponding to different modes may be switched via the operation such as turning, rotating and sliding. Since each input/output portion corresponds to at least a special control keys, the user may identify the function corresponding to each key of the input/output portion easily and directly without enabling software to control the function. Additionally, the switching mode may greatly reduce the occupied space.

These and other features, aspects and advantages of the present invention will become better understood with regard to the following description, appended claims, and accompanying drawings.

### BRIEF DESCRIPTION OF THE DRAWINGS

FIG. 1A, FIG. 1B and FIG. 1C are schematic diagrams showing a portable electronic device with switchable input/output portions in an embodiment of the invention.

FIG. 2A, FIG. 2B and FIG. 2C are schematic diagrams showing the control panels corresponding to various operating modes of the portable electronic device with switchable input/output portions.

FIG. 2D is a schematic diagram showing that switchable input/output portions of the portable electronic device are various output modules in an embodiment of the invention.

FIG. 3 is a schematic diagram showing the control portion of the portable electronic device with switchable input/output portions are switched in an embodiment of the invention.

FIG. 4 is a schematic diagram showing the control portion of the portable electronic device with switchable input/output portions are switched in another embodiments of the invention.

### DETAILED DESCRIPTION OF THE EMBODIMENTS

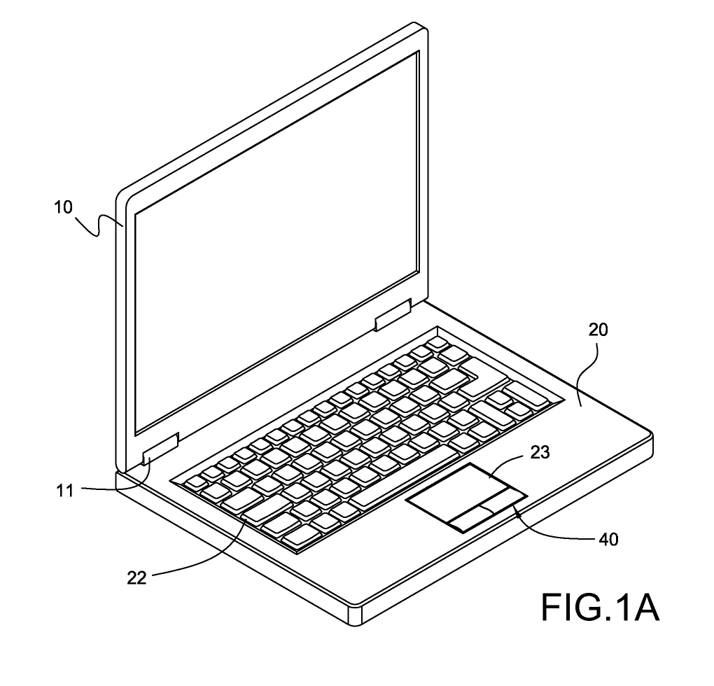

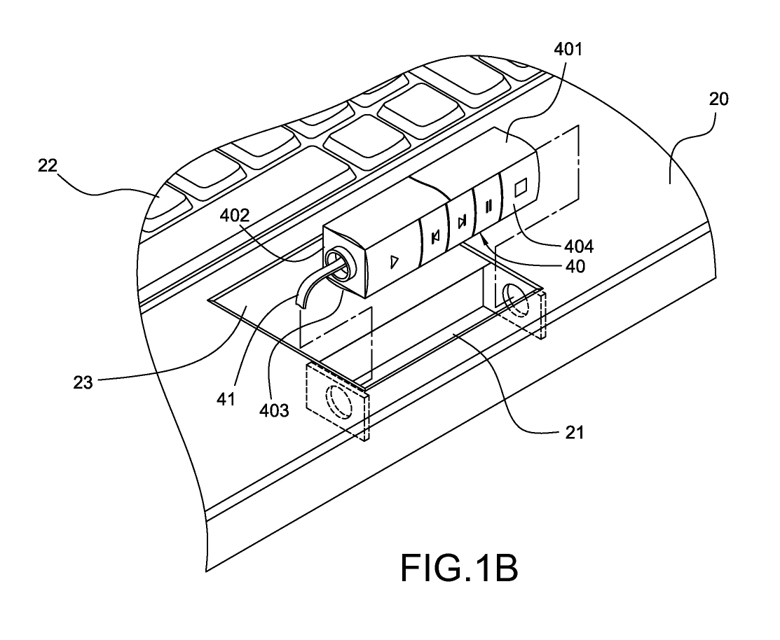

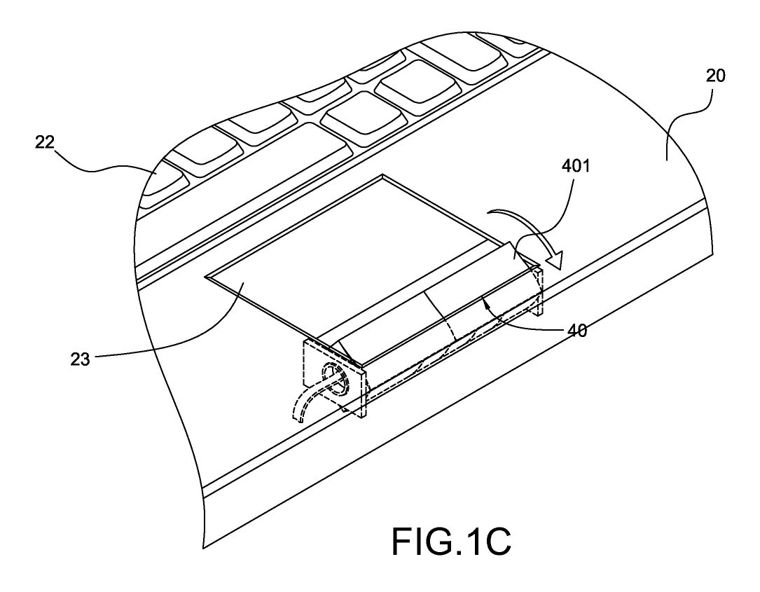

FIG. 1A and FIG. 1B are schematic diagrams showing a portable electronic device with switchable input/output portions in an embodiment of the invention.

The portable electronic device with the switchable input/output portions includes a screen module 10, a main body module 20 and a control portion 40. In FIG. 1A and FIG. 1B, a notebook computer is taken as an example, but the invention is not limited thereto, other various portable electronic devices also may be used.

The main body module 20 includes electronic components such as a motherboard, a central processing unit (CPU), a hard disk, a memory and processing chips to process data. The main body module 20 includes multiple keys 22 and a pointing input portion 23. The screen module 10 includes a bottom 11 for being pivotally connected to the main body module 20 to make the screen module 10 rotate relative to the main body module 20. Therefore, the screen module 10 may be turned to be in an open state, or cover the main body module 20 to be in a closed state. In addition, the screen module 10 is electrically connected to the main body module 20 for displaying the information of the main body module 20.

The control portion 40 is pillar-shaped with multiple surfaces. In FIG. 1B, the control portion 40 is a hexahedron with a first surface 401, a second surface 402, a third surface 403 and a fourth surface 404. Each surface includes an input/output portion, and each input/output portion corresponds to a control panel composed of function keys in a specific operating mode. The control portion 40 is disposed in an opening 21 with two sides pivotally connected to the main body module 21. Only one surface is upward, and its corresponding input/output portion is exposed. As shown in FIG. 1B, the first surface 401 is upward, and thus only the input/output portion in the first surface 401 is exposed to allow the user to operate.

The control portion 40 is electrically connected to the main body module 20 via a connecting line 41 to allow the user to operate and perform the corresponding function. As shown in FIG. 1C, since the control portion 40 is pivotally connected to the main body module 20 at two sides, it may rotate relative to the main body module 20 to be turned over to change the upward surface, and then it switches the input/output portions. The function keys of the input/output portions may be pressing keys or touch control keys.

In FIG. 1C, the input/output portion corresponding to the first surface 401 of the control portion 40 is an input key module. Since the control portion 40 is disposed at the pointing input portion 23 of the main body module 20, the input key module is the left and right keys of the pointing input portion 23. However, the control portion 40 also may be disposed at any position of the main body module 20.

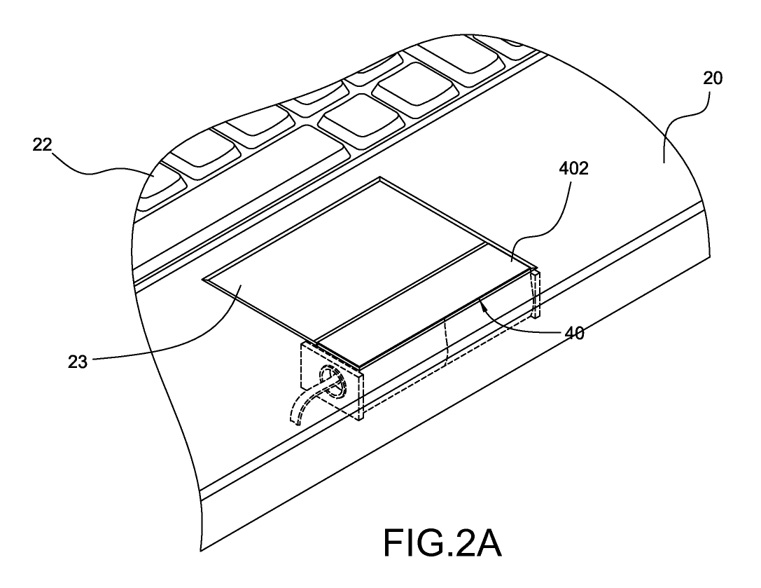

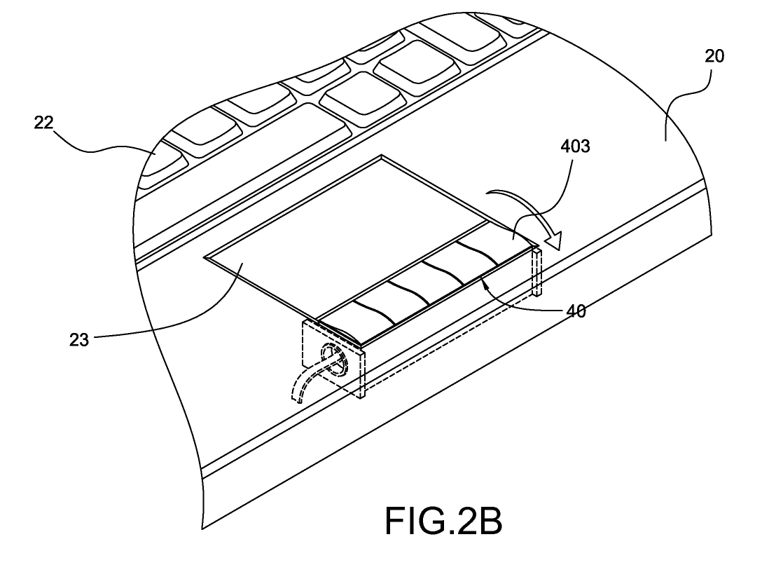

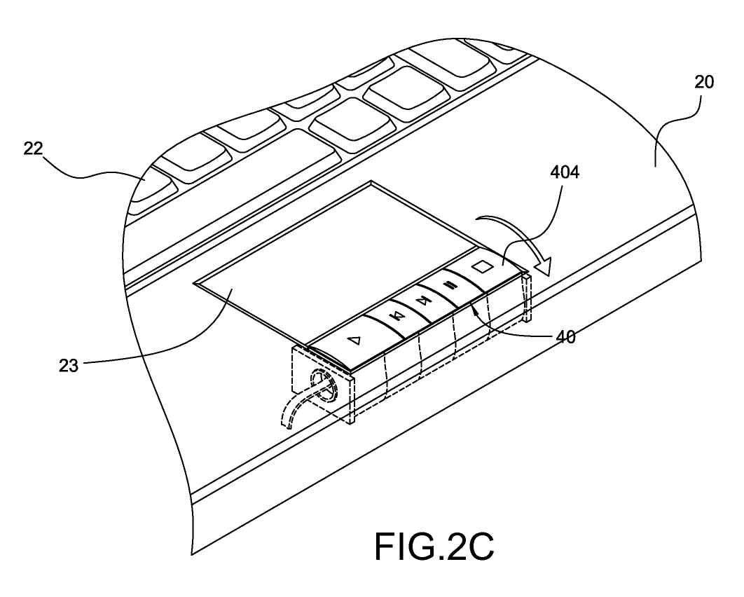

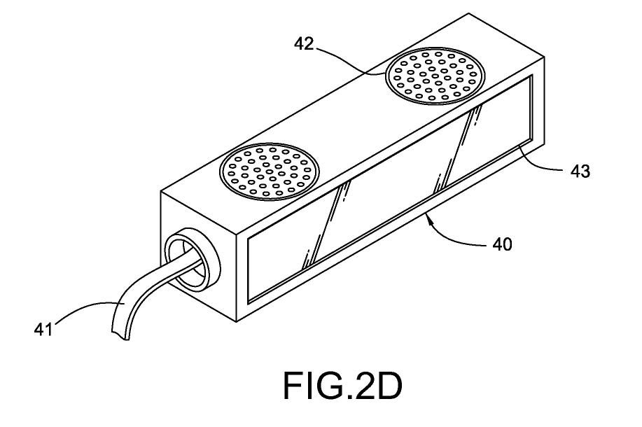

As shown in FIG. 2A, the control portion 40 is rotated again to make the second surface 402 upward, and the input/output portion is an input/output lock portion to disable the pointing input portion 23. The mode is adapted to the standby state of the main body module 20 or the state that the pointing input portion 23 is not used to prevent the user from touching the pointing input portion 23 by mistake.

As shown in FIG. 2B, the control portion 40 continues to be rotated to make the third surface 403 of the control portion 40 upward. The corresponding input/output portion is a hotkey input/output portion to provide multiple user-defined hotkeys. As shown in FIG. 2C, the fourth surface 404 of the control portion 40 is rotated upward, and the corresponding input/output portion is a multi-media player input/output portion to allow the user to operate the multi-media easily. Besides the modes in the above embodiment, the input/output portion also may be a loudspeaker module 42 to provide a surround sound effect or various output modules such as a display module 43 (as shown in FIG. 2D).

Therefore, with the switching mode, multiple functional keys are provided without occupying additional space. The input/output portions in the above modes are just for examples. In addition, the pillar-shaped portion also may include more surfaces to increase the number of the control panels or the output modules corresponding to different operating modes.

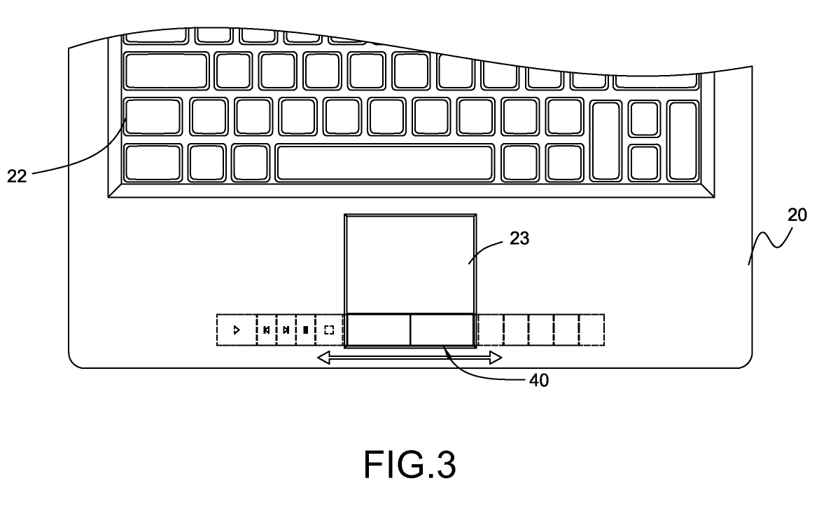

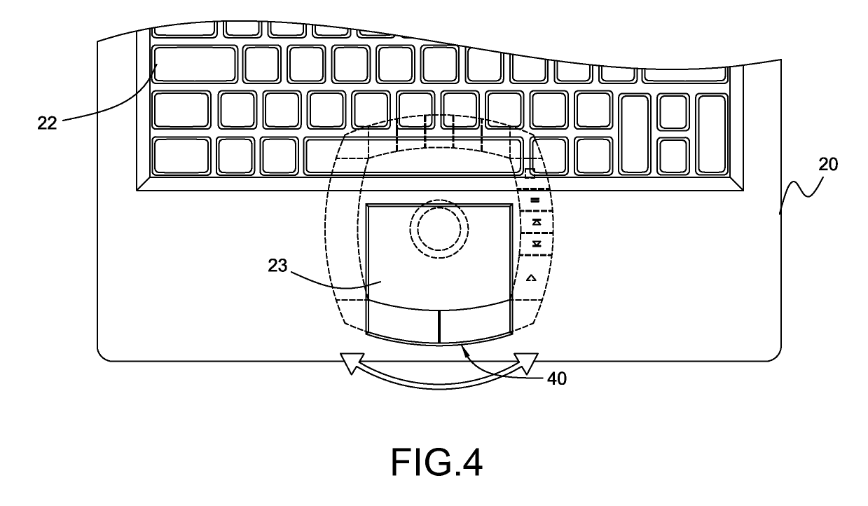

As shown in FIG. 3, besides pillar-shaped, the control portion 40 also may be strip-shaped to be slidingly disposed at the main body module 20, and the input/output portions may be switched in a sliding mode. Moreover, it also may be disk-shaped to be rotatably disposed in the main body module 20, and the input/output portions are switched in a rotating mode as shown in FIG. 4.

To sum up, in the portable electronic device with the switchable input/output portions, the main body module includes a switchable control portion. By the operations such as turning, sliding and rotating, different input/output portions of the control portion are exposed to allow the user to operate correspondingly. Since each input/output portion corresponds to a specific operating mode, the user may know the corresponding functions intuitively, which not only facilitates the operation but also is space-saving.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A portable electronic device, comprising:
a main body module having an opening; and
a control portion disposed in the main body module, wherein a part of the control portion is exposed from the main body module via the opening, the control portion includes a plurality of input/output portions, and the input/output portions are switched selectively to make one of the input/output portions exposed.

2. The portable electronic device according to claim 1, wherein the input/output portion is a loudspeaker module or a display module.

3. The portable electronic device according to claim 1, wherein the input/output portion is a control panel.

4. The portable electronic device according to claim 3, wherein the control panel is an input key module, a multi-media player control module, a hotkey control module or a lock control module.

5. The portable electronic device according to claim 1, wherein the main body module includes multiple keys and a pointing input portion, and the opening is formed at the pointing input portion.
